(19) United States
(12) Patent Application Publication
(10) Pub. No.: US 2007/0124312 A1
(43) Pub. Date: May 31, 2007

(54) Structured Communication System and Method

(76) Inventors: Todd Simpson, Calgary (CA); Danny Jaliff, Calgary (CA); Richard Plana, Calgary (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 11/551,117

(22) Filed: Oct. 19, 2006

Related U.S. Application Data
(63) Continuation-in-part of application No. 10/774,877, filed on Feb. 10, 2004.
(60) Provisional application No. 60/319,951, filed on Feb. 17, 2003.

(51) Int. Cl. G06F 17/30; G06F 7/00

(52) U.S. Cl. 707/10

(57) ABSTRACT

This invention presents a novel way in which electronic communication can be carried out, wherein the context of the communication is established by negotiation between the sender and receiver, whereby the communication can be properly categorized and filed.

### CROSS-REFERENCE TO RELATED APPLICATIONS

This application is a continuation-in-part application of U.S. application Ser. No. 10/774,877 filed Feb. 10, 2004, which is a non-provisional version of U.S. provisional application No. 60/319,951 filed Feb. 17, 2003.

### BACKGROUND OF INVENTION

The growth of the Internet has led to an ever-increasing, amount of unstructured communication. This communication is largely accomplished via electronic mail (“e-mail”), instant messaging systems and blogging, as well as, to a smaller extent, data transfer means such as ftp (a computer file exchange program based on “File Transfer Protocol”). Voice-over-IP (VoIP) protocols also provide a mechanism enabling voice communication between users over a telecommunication network, as well as broadcasting of voice messages over the Internet from one user to many users. In general, the communication tends to be more focused on information itself that is being exchanged or communicated, without adequate attention paid to its relationship to other information.

Human communication is largely organized by context. It is believed that context helps human brains cross-reference information and retrieve information from memory. Context may take different forms. For example, business processes are contexts, such as working on a particular project or working with a particular colleague. Personal relationships, such as family members, relatives, friends, co-workers, are contexts. Contexts can also be areas of interest, such as hobbies, religion, travel or a geographic location, such as home, work, or foreign country. Contexts can also be the subject of conversation or information. A library is one example of organizing information based on categories of subject matter.

Consider e-mail and instant messaging. E-mail communication accomplished via existing e-mail systems can be characterized as being a one-way broadcast of information having a sender and at least one receiver. E-mail is non-real time and asynchronous (from the viewpoint of a human). The sender composes the message and provides some indication as to the nature of the message in a header line. The receiver does not have to read e-mail messages immediately, nor do they need to respond immediately or at all. The receiver typically categorizes an e-mail message he receives based upon the sender's name or keywords in the header line or message.

E-mail users may spend significant fraction of working hours in managing e-mail messages and reconstructing the context. Much of this effort tends to be spent in reading messages to make sense of the context of a received message, deciding whether or when a specific response action is required, and attempting to categorize the message with the appropriate context for future reference—filing away into “folders” being a commonly used mechanism to achieve the latter goal. Finding old emails can also be problematic if the context it was stored under is not remembered accurately. Common existing mechanisms aimed at automating some of this work, such as e-mail message handling rules and filters often are inadequate, as they are based on limited information such as message origin and keywords, and therefore remain error prone.

Instant messaging is real-time and synchronous. There is usually a dialog, back and forth between the participants, requiring a timely response. Instant messaging, like human dialog, tends to first establish the context of the interaction (what the conversation is about), and then proceed to a more meaningful exchange of information. However, existing instant messaging tools generally do not require users to record the context nor provide tools to facilitate establishing new context when it is introduced in a dialog. After an instant messaging session is concluded, typically, only a transcript of the session is recorded, without a corresponding context. A user is still left with the task, after the fact, of reconstructing the context of the session transcript.

Thus, the increase in unstructured information communicated has led to an increase in the amount of time a user spends sorting, organizing, and retrieving their communication information.

There therefore exists a need of facilitating structured communication so that the communicated information can be easily organized and a need of organizing communicated information for easy cross-reference and retrieval.

### SUMMARY OF INVENTION

This invention pertains to the exchange of electronic or digital information, and more specifically to an e-mail-like exchange wherein the categorization of information being communicated is more easily controlled and exposed. Advantageously, the responsibility for message management is delegated to a sender of the message, as opposed to the recipient, but under rules imposed by a recipient.

The invention attempts to address a need for a non-real time, asynchronous communications system with the advantages of negotiating a context for communicated information. Because of the asynchronous nature of the system, an interactive dialog between a sender and a receiver to set a context may not be possible as the receiver may not be available at that time. To address this difficulty, either the context can be transmitted in a more structured form (perhaps relying on a-priori information about the receiver) to facilitate automated context setting, or the context can be negotiated between an agent for the sender and an agent for the receiver when a message is being sent. A third party can also help negotiate the context between these two agents.

In a broad aspect, the invention provides a system for categorizing information communicated by users of a message exchange system, be it synchronous or asynchronous. The categorization system includes a categorization server and a plurality of negotiation agents that can be connected to the categorization server when needed. The categorization server has access to one or more representations of categorization of information, such as a list of categories, each category optionally having attributes assigned thereto. In general, a representation of categorization includes categories and their attributes and relationships. The relationships may be hierarchical, or “flat” (i.e., undifferentiated), among others. A user's representation of categorization may be defined by the user, may be one recognized by the user, or may be one considered as acceptable by the user. When a sender sends a message to a receiver, the sender uses a negotiation agent to negotiate with a negotiation agent of the receiver, in order to identify a category for the message. The category is identified based on the representation of categorization provided by the categorization server. It may be one selected from the receiver's representation of categorization, may be one added to the receiver's representation, or may be mapped from one category selected from the receiver's representation, among others.

The categorization server may further include a category directory service module for storing representations of categorization and serving them to users upon request. The category directory service responds to queries by supplying names and attributes of categories and relationships between categories, if any. It may be a software application or process executing on a user's computer, an enterprise server or a computer that may be accessed remotely, such as through the Internet.

Optionally, the categorization server may authenticate a sender first and provide a receiver's representation of categorization only upon the sender being authenticated The categorization server may selectively provide portions of the receiver's representation of categorization to the sender, based on the sender's authorization level, or permissions. Either the system or the receiver may pre-assign the permissions.

Each of the negotiation agents includes a communication interface for connecting the negotiation agent to another negotiation agent. During a negotiation session, the sender's agent requests a representation of categorization from the receiver's negotiation agent or directly from the categorization server, or from a cache of the receiver's categorization stored locally or on an enterprise server. The categorization server or the receiver's negotiation agent provides the requested representation to the sender negotiation agent. A category is identified through the negotiation. The identified category is associated with the message, either before, during or after transmission of the message from the sender to the receiver. Preferably, a reference to the identified category is transmitted together with the message.

In another aspect, there is provided a message exchange system that includes a plurality of user clients for users to create, exchange and manage messages, a plurality of negotiation agents for categorizing messages communicated by the users and a categorization server. The categorization server has access to one or more representations of categorization of information. A message exchange server may also be provided for exchanging messages on behalf of the users. When a sender creates a message for sending to a receiver, the sender's user client connects to a negotiation agent. The negotiation agent for the sender negotiates with a negotiation agent of the receiver, to identify a category for the message based on the representation provided by the categorization server. A category is identified through a negotiation session between the receiver's negotiation agent and the sender's negotiation agent. The identified category is associated with the message, either before, during or after transmission of the message from the sender to the receiver.

In yet another aspect of the invention, there is provided a method of categorizing information. The method includes the steps of providing an initial representation of categorization of information, the representation including a plurality of categories, the initial representation being provided in a session of receiving the information from a sender; negotiating with the sender to make a modification to the initial representation during the session for categorizing the received information; associating a category with the received information, the category being negotiated based on the modified representation; and providing the modified representation in subsequent sessions of receiving further information.

In a feature of this aspect of the invention, the modification includes a mapping between a first category in the plurality of categories and a second category included in the sender's representation of categorization. In another feature of this aspect of the invention, the modification includes at least one of adding a first new category to the plurality of categories, adding a second new category to the sender's representation of categorization, and mapping one of the first new category and the second new category to the category. In yet another feature, the method includes the further steps of querying a categorization server to obtain a second mapping between the second category and a third category in an intermediate user's representation of categorization and a third mapping between the first category and the third category, and forming the mapping from the second mapping and the third mapping by chaining the second and third mappings.

In yet another aspect of the invention, there is provided a method of transmitting messages in a message exchange system. The message exchange system has a user agent for transmitting a message to a receiver, and a categorization server for supplying a listing of categories. The method includes the steps of obtaining the listing of categories from the categorization server; negotiating a category with the receiver, said category being selected based on the listing of categories; associating the message with the category; and sending the message associated with the category to the receiver.

In a feature of this aspect of the invention, the listing of categories includes a system portion shared by users of the message exchange system and a private portion, and the step of obtaining the listing of categories includes obtaining the system portion and the private portion; and combining the system portion and the private portion to produce the listing of categories.

In a further feature, the step of negotiating the category includes at least one of selecting the category from the system portion, selecting the category from the private portion, and establishing a mapping between the category and a second category selected from the private portion.

In another feature of this aspect of the invention, the method includes the further steps of authenticating the sender, determining a permission level of the sender, and publishing a restricted listing of categories based on the permission level. The step of obtaining the listing of categories includes obtaining the restricted listing of categories and the step of negotiating includes one of selecting the category from the restricted listing and establishing a mapping between the category and a second category selected from the restricted listing.

In other aspects the invention provides various combinations and subsets of the aspects described above.

### BRIEF DESCRIPTION OF DRAWINGS

For the purposes of description, but not of limitation, the foregoing and other aspects of the invention are explained in greater detail with reference to the accompanying drawings.

FIG. 1 shows a general electronic mail system, at the levels of user actions and agent actions.

FIG. 2 shows an electronic mail system with the addition of negotiation for the context of the message.

FIG. 3 abstract FIG. 2 into major components.

FIG. 4 shows the present invention with an intermediary helping to negotiate the context for the message.

FIG. 5 shows the system with messaging gateways.

FIG. 6 shows the system with multiple recipients of a message.

FIG. 7 shows the combination of multiple recipients and an intermediary.

FIG. 8 shows the use of multiple intermediaries.

FIG. 9 shows a user's view of the context setting system.

FIG. 10 shows a user's view of the context setting system when multiple recipients are involved, and all recipients have the same context.

FIG. 11 shows a user's view of the context setting system when multiple recipients are involved and each recipient has a different context.

FIG. 12 shows a representation of categories linked in a tree-like structure according to an embodiment of the present invention.

FIG. 13 shows in block diagram major components of a system for categorizing and exchanging messages according to an embodiment of the present invention.

FIG. 14 shows steps of a process for categorizing an outgoing message.

FIG. 15 shows portions of an alternative process for categorizing an outgoing message.

FIG. 16 shows steps of a process for selecting an active profile.

### DETAILED DESCRIPTION OF EMBODIMENTS

The description which follows and the embodiments described therein are provided by way of illustration of an example, or examples, of particular embodiments of the principles of the present invention. These examples are provided for the purposes of explanation, and not limitation, of those principles and of the invention. In the description which follows, like parts are marked throughout the specification and the drawings with the same respective reference numerals.

As used throughout this specification, the term “agent” refers to an automated system that, once configured by a user, has some independence of action. An intelligent agent may change its behavior over time based upon its interactions with other users and/or other agents. An agent may be distributed or local, autonomous or controlled. Thus, for our purposes, an agent can be any software system, or a combination of software and hardware (or firmware) systems.

A sender of a message has the increased responsibility to categorize information being sent out. At the time that communication is initiated, the sender tends to have more information about the context than the receiver. This information about context is valuable, and should be used to help the receiver categorize the communication in more than an ad-hoc, post receipt, manner (such as reading the subject line, or scanning for keywords). Instead, both the sender's and the receiver's preferences for categorization should be unified as the message is composed and sent, so that it is properly indexed for all users.

Generally speaking, any knowledge representation of context or categories may be used for categorizing information, as long as that representation allows a means for unifying two or more categories. Here, “unifying” means arriving at a common representation that is acceptable to both parties. For example, in a generic knowledge representation framework, unification may consist of finding the smallest subset that contains all categories. Alternatively, unification may be achieved by establishing a temporary or persistent mapping between categories in two different representations. In a neural network, unification may consist of inserting all categories as the inputs to the neural network and then recording the output value. The knowledge representation structure may be distributed or local or both. The current invention does not require any particular representation. It does, however, assume the existence of a representation, such as a listing of categories and any relationship that may link these categories together, though such a structure is not always necessary.

The present invention provides a communications system with the advantages of negotiating contexts or categories on behalf of users for associating the categories with communicated information such as e-mail messages. As an example, a communications system, such as an e-mail system, generally includes a sending subsystem for sending outgoing messages and a receiving subsystem for receiving messages on behalf of a receiver. The sending subsystem generally includes a user interface. Through the user interface, a sender can categorize an outgoing message, for example, select a category and associate the category with the outgoing message. For the category to be acceptable to the receiver, the category can be selected from ones that are recognized by the receiving subsystem. Alternatively, the sending subsystem can include a negotiation unit that communicates with the receiving subsystem to identify a category and associate the category with the message. The negotiation between the sending subsystem and the receiving subsystem identifies a category that is acceptable to or recognized by both the sender and the receiver. The category may be selected from a list of categories provided by the receiver or receiving subsystem, or one mapped from a member of the list of categories. When identifying the category, the sending subsystem can use information about the receiver, such as how the receiver categorizes information, whether the receiver wishes to receive certain categories of information, or even presence information about the receiver.

The sending subsystem can also negotiate with an intermediary for the receiver, or through another intermediary for the sender with the intermediary for the receiver, to categorize the message so that the category is acceptable to both the receiver and the sender. This may occur, for example, when the receiver is not online. Optionally or alternatively, the sending subsystem can negotiate with an intermediary and the receiving subsystem concurrently and unify the results of negotiation with both. Either the sending subsystem or the receiving subsystem, or the sender or receiver intermediaries, can select other intermediaries. Either the sending or the receiving subsystem can also include a search unit for searching and identifying such intermediaries. Alternatively or additionally, either the sending or the receiving subsystem, or both, can include an intermediary directory for selecting and identifying an intermediary or intermediaries.

Either or both sending and receiving subsystems may have a storage unit. Outgoing and received messages, categorized by the system, can be stored based on the associated categories. For example, messages associated with the same category can be stored together, separate from messages associated with other categories. Storing messages in category-based “folders”, or logical storage areas, is one such example. The messages can also be indexed based on categorization, as well as other parameters (such as weighting based on frequency of use, temporal use, etc). This facilitates the later retrieval of messages. The categorization based storing and indexing of messages allows for intelligent filing of messages. In addition, categorized messages also permit searching these messages based on categories associated with the messages.

As another example of categorization based classification of messages, a negotiation subsystem can be built into a communications system for classifying outgoing messages. Outgoing messages are categorized, namely each message having a category associated therewith. The negotiation subsystem can include an agent for a receiver and an agent for a sender. The sender agent and the receiver agent negotiate a category that is mutually acceptable to both the sender and the receiver. For example, the category may be selected by the sender agent from a list of categories provided by the receiver agent, or one mapped from a member of the list of categories. The negotiation subsystem can be configured so that the sender and the receiver agents negotiate a category without much user intervention, or it can be configured so that the negotiation is guided with input from the sender. Similarly, the negotiation subsystem can also include an intermediary agent for automatically mediating the categorization between the sender agent and the receiver agent, or between the sender and the receiver agent.

Conveniently, a categorization server is provided so that the categorization server can supply copies of representations of categorization when requested. The representations of categorization served may have a common portion shared by all users. The common portion may be regarded as a system portion and can be managed by the system. The portions of representations not shared by all users may be regarded as private portions. The system provides means for unifying the system portion with a user's private portion to form a complete representation of the user's representation of categorization. More generally, the system portion, a user's private portion and a third party's representation of categorization can be combined to form a unified representation of categorization. Both the system portion and the private portions may be modified and updated, which allows the evolution of representations of categorization. A user may also have more than one representation of categorization. One such representation may be designated, either by the user or automatically designated when certain conditions are met. During a negotiation session, the active representation of categorization will be used.

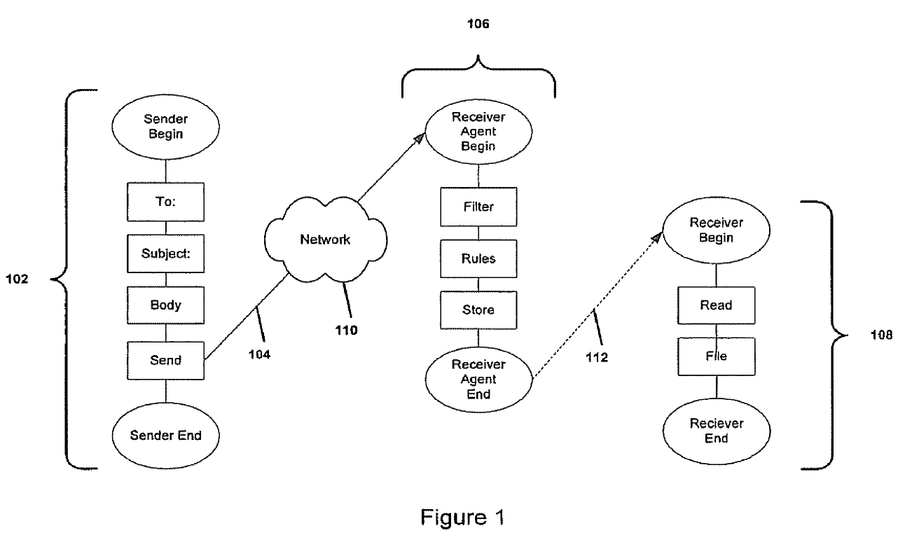

FIG. 1 shows a generic e-mail application. Component 102, which we call the sender, represents a user who sends a message as well as user actions of the user, such as deciding who the message will be sent to, the subject of the message, composing the body of the message, and the send command. The send command results in the transfer of the message, 104, through the network, 110. Message transfer 104 is intended to capture the standard Internet protocol for addressing and delivering a message, or any other means of finding the receiver and delivering a message. The receiver agent, 106, typically filters and removes unwanted e-mail, runs e-mail rules to file messages, and then stores the message. The human receiver, 108, then reads and potentially files the message, or responds to the message.

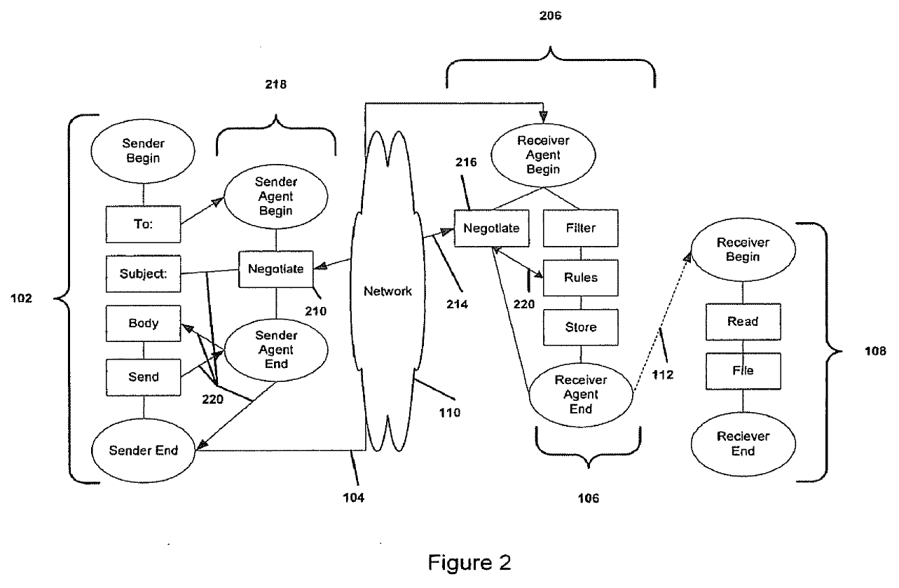

FIG. 2 shows a sender, in one embodiment, categorizes a message. There is either a simple or complex interaction between the sender and a sender agent. During, before, or after a message composition, the sender agent must negotiate, 210, the categorization of the message with the receiver agent, 206, which has been modified with the ability to negotiate, 216. This negotiation occurs over the network, 110, using any type of communication scheme, 214. The receiver negotiation and categorization will be based upon some knowledge of the recipient's desires and/or file structure and may be influenced by the filtering or rules, 220, that the receiver has in place. The categorization may be based upon any type of knowledge representation. As will be described later, during a negotiation, the receiver agent or an intermediary provides the knowledge of the receiver, such as how the receiver categorizes information, to the sender agent, based on which the sender agent determines a suitable category. The suitable category may be one selected from a list of categories provided by the receiver agent or, if the receiver agent allows creation of a new category by the sender agent, a new category created by the sender agent and then shared by both the sender agent and the receiver agent. In other words, a suitable category is one that is recognized or accepted by both the sender agent and the receiver agent, a “common ground” between the sender's expectation of categorization and the receiver's categorization.

The sender's categorization may be influenced not only by the receiver, but also by information in the body or subject, 220, as well as any type of knowledge representation of the sender's preferences. Thus, FIG. 2 shows an interplay in the composition of a message which puts some of the responsibility for categorization on the sender and the sender agent. As shown in FIG. 2, in one exemplary process, sender agent first receives from sender a receiver's address, extracted from the “To:” field of a message. The sender agent then initiates the negotiation process and communicates with a receiver agent for the receiver so identified. A category may be negotiated and determined at this time. As the sender enters more information, such as “Subject” or body of the message, the sender agent can use the additional information to update the category negotiated or start negotiate a new category based on the additional information. As shown in FIG. 2, this negotiation 210 is between the sender agent and the receiver agent over the network 110, using any type of communication scheme 214.

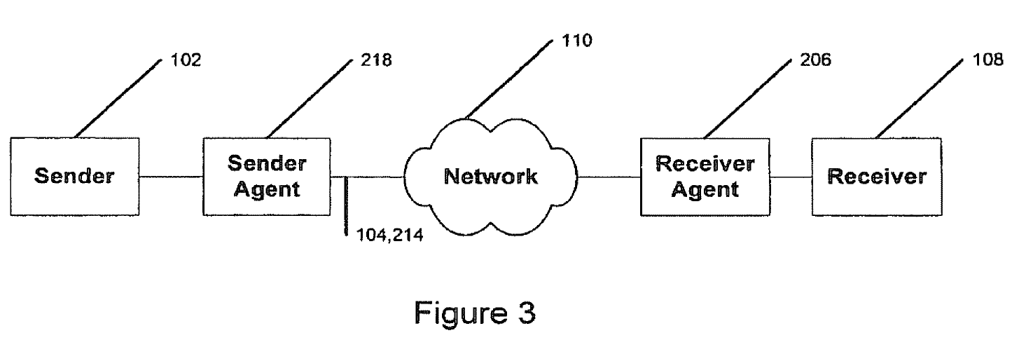

FIG. 3 provides another view of electronic dialog, which depicts the sender, 102, the sender agent, 218, the network, 110, the receiver agent, 206, the receiver, 108, and the methods of communication, 104 and 214 in one figure. From hereon we will use message transfer protocol 104 as a proxy for both message transfer 104 and communication scheme 214 under the assumption that the same underlying protocol is used for both category negotiation and message delivery. This should not in any way restrict the current invention from cases where the two methods differ.

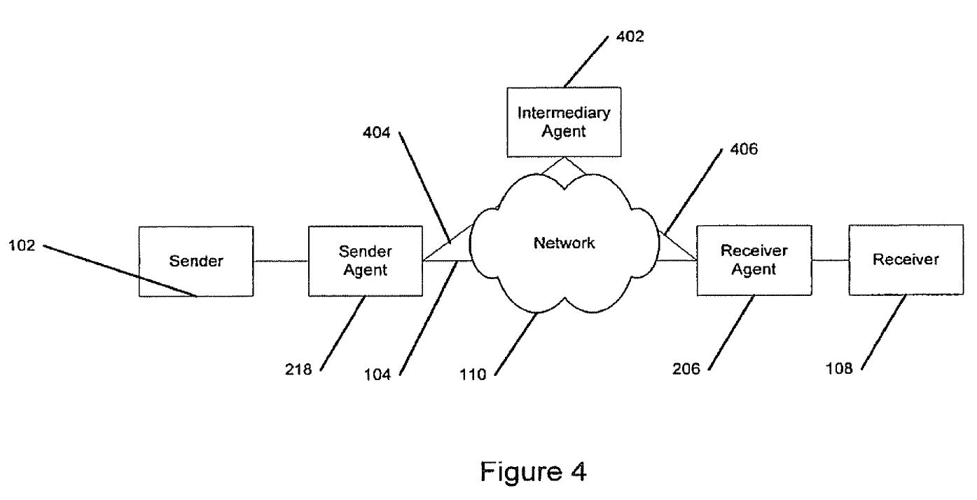

Implicit on both the sender and the receiver sides is a representation of applicable categories, such as a listing of categories, as well as, potentially, the ability for learning of categorization, or even the ability for the sender to update the receiver's categorization and/or knowledge representation. In FIG. 4 we generalize this idea to include an intermediary agent, 402. This agent may have knowledge of general categorizations with a world view, or an enterprise view, for example. The sender agent, and therefore the sender, can interact with the intermediate agent over link 404, and the receiver agent, and therefore the receiver, can interact over link 406. These communications are in addition to, not to the exclusion of, link 104. In this case the negotiation for a proper categorization is three way. The intermediary may use a standardized set of categories, or a sect of categories reflecting an industry viewpoint. Either the sender or the receiver can nominate an intermediary.

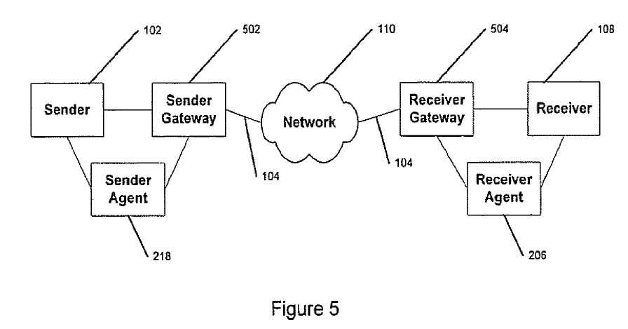

In FIG. 5 we show that gateways can be either transparent to, or participants in, a categorization. The sender gateway, 502, and the receiver gateway, 504, may be categorization agents in their own right or they may simply pass information. An example of participation would be enterprise based filtering of some content types (e.g., humor, or pornographic material).

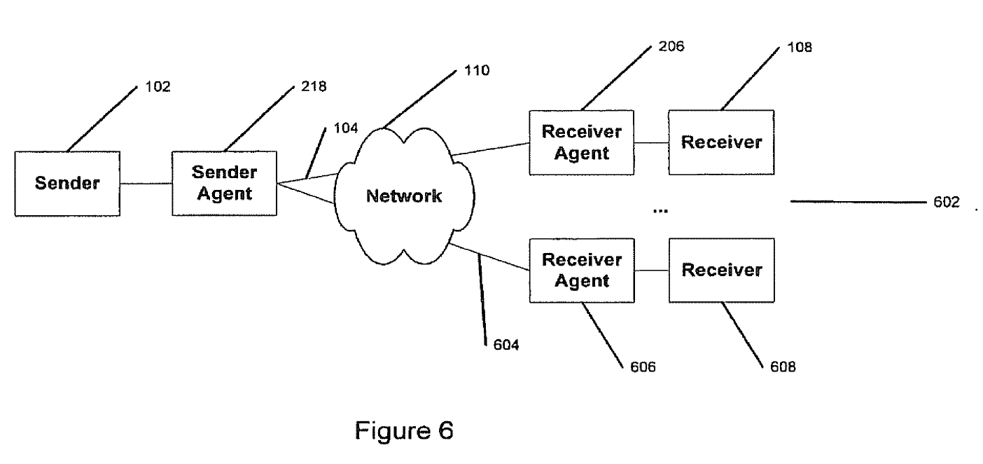

FIG. 6 shows the system with multiple receivers, 108 and 608, as well as receiver agents, 206, 606. Two receivers have been shown, although in general any number of receivers can be addressed, shown by ellipsis “. . . ” 602. The categorization procedure in this case can occur between the sender agent directly with each recipient, 104 and 604, resulting in potentially different categories for each user, or the sender agent may unify the category for both recipients based on negotiation with both.

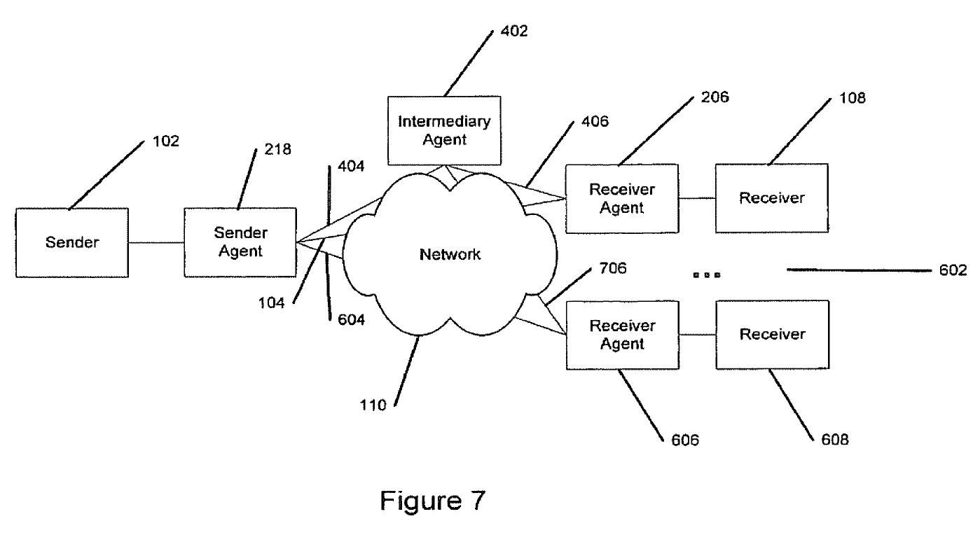

FIG. 7 generalizes FIG. 6 to the case where there is an intermediary agent. In this case communication is possible between all of the parties, namely, sender agent, intermediary agent, and multiple receiver agents, adding links such as 706, between a receiver agent 606 and an intermediary agent 402 or sender agent 218.

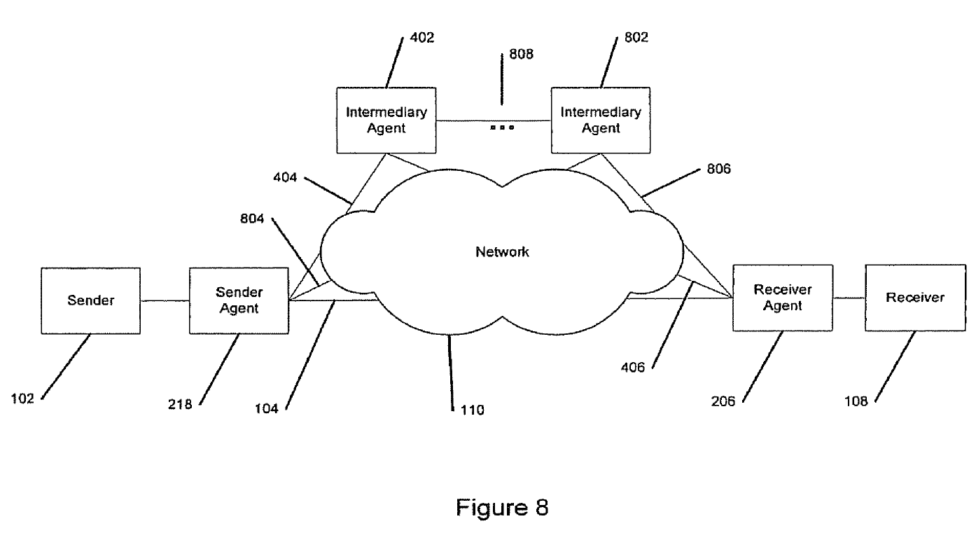

FIG. 8 generalizes once more to multiple intermediaries and the question of who controls the interaction becomes prevalent. Again, either a sender or a receiver (or their respective agents) can nominate an intermediary, meaning that each receiver may nominate a different intermediary. As long as the intermediaries can all access one another, the unification of the categorization can proceed. As the sender is often an endpoint with access to knowledge of all intermediaries (under the assumption that multiple recipients have no knowledge of each other for example in the case of blind carbon copies), the management role generally falls to the sender. If the sender nominates an intermediary, it can also pass on the address of other intermediaries, so the intermediaries can negotiate at one layer removed from the sender and the receiver. This is shown in FIG. 8, for example, as intermediary agent 802 negotiating with another intermediary agent 402 over link 808 and with receiver agent 206 over link 806.

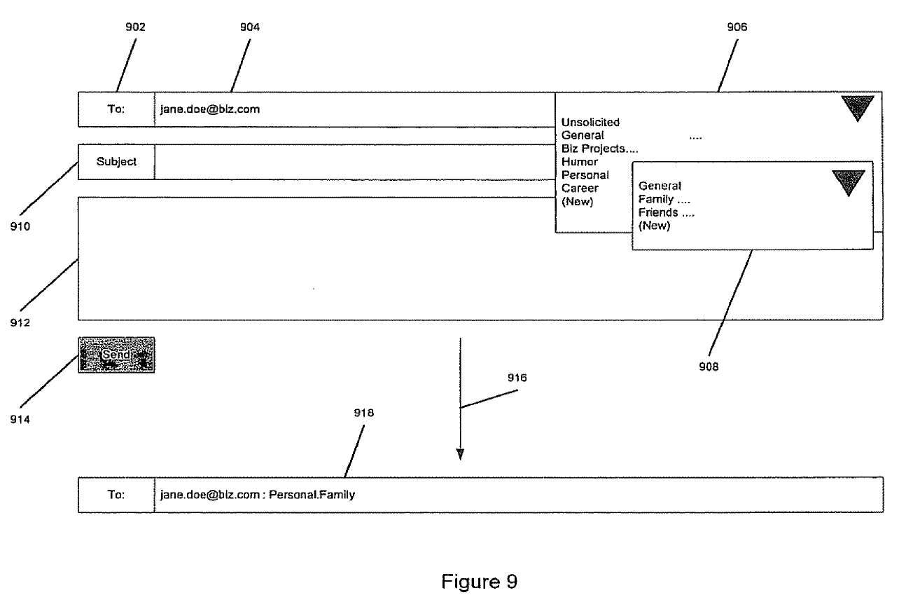

FIG. 9 reflects one possible user view of the interaction. Here a message is being sent to Jane Doe, 904. Categorization information, for example in the form of a list of categories known to the receiver, has been presented to the sender for selection in a dropdown list 906 and submenu 908. Behind the scenes the sender agent, given the information jane.doe@biz.com, 904, was able to negotiate these categories with the receiver agent for receiver “Jane Doe”. As an interactive example, the sender traverses the categories to “personal” in dropdown list 906, and retrieves the submenu 908 under the category “personal”. Within the submenu 908 there are three active subcategories, and one inactive one. The sender can select an active category and complete the negotiation process. The inactive category, “General”, indicates that Jane has a “Personal.General” category, but that it is not available to this sender. However, Jane also has a “(New)” category, meaning that she is willing to negotiate (herself or through her agent) a new category for this sender. Such a category may only be exposed to this sender, not others, or it may be made public and available for all. The sender can also use the “(New)” category to create a category to be associated with the message and complete the negotiation process. We also see in the dropdown list 906 a category for “Biz Projects” which has company specific categories in it. These categories may be driven by an enterprise intermediary, and can be consistent across all “Biz” employees. A selection of a category would result in a reflection of the selected data in the “To:” field, 918.

The dropdown list 906 and submenu 908, in combination, provide a representation of a hierarchical structure of the categories belonging to the list. As will be appreciated, each item in the submenu 908 can have its own submenu, and so on and so forth. This can provide a hierarchical structure of as many levels as desirable, though probably it is only practical to present a hierarchical structure of only a few levels. However, any other suitable means, such as collapsible “trees”, may be employed to present a hierarchical structure or a representation of categorization. A simple dropdown list without any submenu, on the other hand, may be used for representing categories where no hierarchical structure exists.

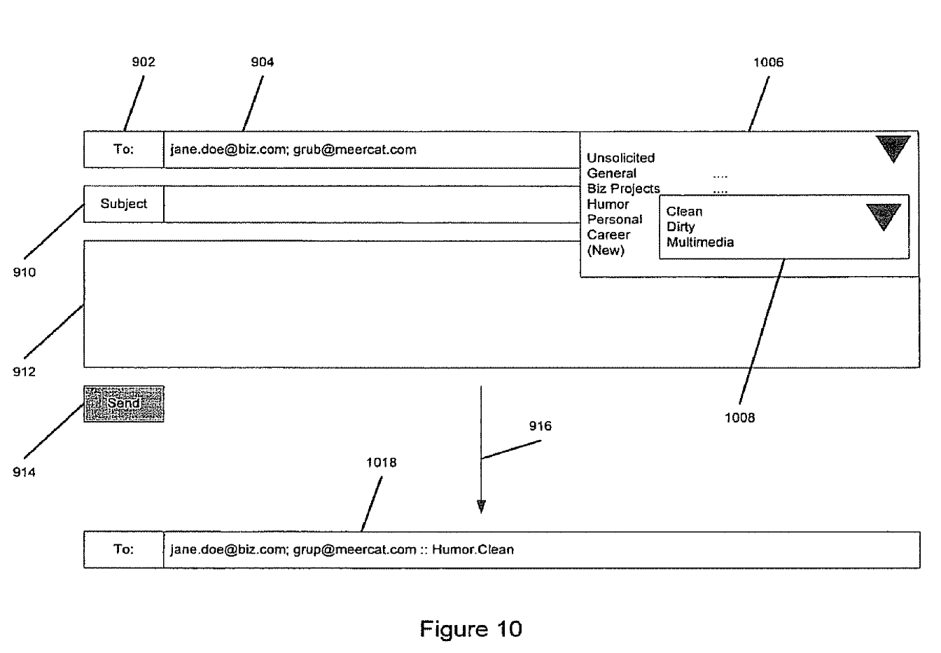

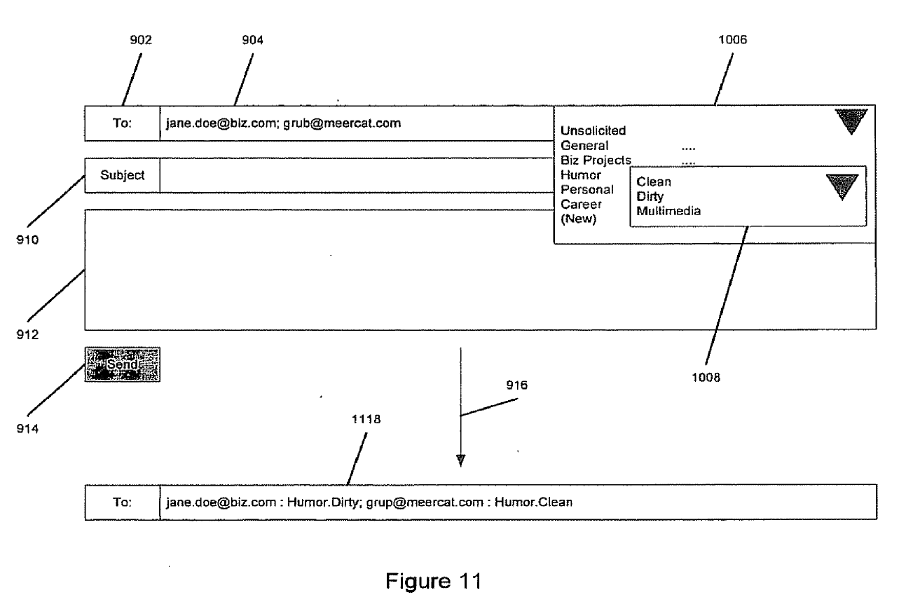

FIG. 10 shows the same view where multiple recipients are named. In this case a category, “Humor.Clean”, 1018, has been negotiated and applied to both users. As will be understood, the category “Humor.Clean” is not restricted to be applied to only two users. It may be applied to more users as well. FIG. 11 shows where different categories have been assigned to different recipients, 1118, which provides an example of mapping one category in one user's list of categories to another category in another user's list of categories.

These interfaces are presented for description only and could be developed in many different ways. In particular, categorization may not occur until after the subject field is filled, 910, the body is filled, 912, or the send button pressed, 914. The first two of these examples may provide more information to the categorization process for example, keywords in the subject. Further, an indication of the negotiated category may not necessarily be placed in the “To:” field, but may be in the subject field or the body, or even as an attachment, hidden or not. The indication of the negotiated category may be placed in any section of the message (for example, as a MIME type). More generally, it does not even need to be in the message, as long as the category is associated with the message. For example, it is entirely possible that an indication of the negotiated category is placed directly in a receiver's file system by the receiver's agent and the indication is associated with a message number that identifies the message, yet to be delivered. This will enable a web services-like process that runs in parallel with e-mail processes, as opposed to inside an e-mail processes.

Further, as will be appreciated, although an example of interactive categorization through the user interface is described here, the system can be configured to automate the categorization process so that the sender agent automatically negotiates a category with the receiver agent. Different means may be provided for configuring the sender agent, the receiver agent, the negotiation subsystem or the system as a whole to automatically negotiate a category, or allow a user's participation in the negotiation of categorization. For example, interactive menu selection through a user interface may be provided for configuring a sender agent or a receiver agent. Other means are also possible, including use of system configuration parameters, command line options or any other suitable means, as known to those skilled in the art.

Presence information (such as whether a user is online, whether they are accepting messages, whether they want to be involved in categorization) can also be used to guide the system. This allows the system to present representations of categorization and the subsequently categorizing information in a context sensitive manner. For example, information transmitted by instant messenger may be “real time” and can be categorized as such. This allows all information received in real time, such as session transcript of an instant messenger session, digital recording of a telephone conversation, or multimedia recording of a slide presentation including audio recording, video clips, graphics, texts etc., all be associated with a category named “real time”. In addition, one can also categorize such information based on its contents, so that some may be categorized as “Biz.Project”, others may be categorized as “Biz.Product.Marketing”, while yet some others may be categorized as “General.Sports”. Additionally, categorization may also be dynamically changed from one to another based on presence information. For example, if a user's presence information showed the user to be on holidays for two weeks, the categorization of a message that requires a response within five days may dynamically change from “reply required” to “FYI”. The presence information may also include a user's indication whether they wish to categorize information using a restricted set of categories, by, for example, limiting categories to those selected from a pared down list. The “context” may also be a user's geographic location, device type of communication device, whether a user is working, or some other attributes. For example, a user may be working, but is at an overseas office. Thus, a categorization of “Sporting Events” may not need to differentiate one local game (local to the home office) from another local game, but instead, it may be more desirable that the system presents a more refined categorization of events or news related to games local to the overseas office and categorizes these spoilt events and news accordingly.

As illustrated in the examples above, categorizing a message, i.e., associating a message with one of the categories, provides the context of the message. Advantageously, a categorization model, or categorization structure, can be defined to represent a user's view how knowledge should be categorized and how the user's categories relate to each other. In one example, a model is a tree where each node is a category. Each node may also have attributes, such as “public”, “integer”, etc. Attributes may also have their own attributes, and so on and so forth. A terminating node, i.e., a node that is not internal, is also called a leaf The starting node is called “root”. A path from the root to a leaf, linking several categories, or nodes, is called a category path. Conveniently, a category “tree” can be expressed using the following notation:
A, B, . . . —Category names
A.B.C. . . . —Category path in a category tree:
   If the path ends in a period, it is a full path to a leaf
   If the path ends without a period, it is an internal node
{a=X,b=Y, . . . }—Attributes of nodes along a category path, where each of attributes X, Y is written “j:v”, where
   j is the attribute category
   v is the value of the attribute
      Using this notation, a category expressed as World.Work.Humor{World=Privacy:Private,Work=Privacy:Enterprise,Humor=Privacy:Public,Time=All,Location=All) means a category “Humor” that is part of family “Work”, which is in turn part of family “World”. Here, the “Privacy” attribute controls the group of users to which the category is exposed, as will be described later.

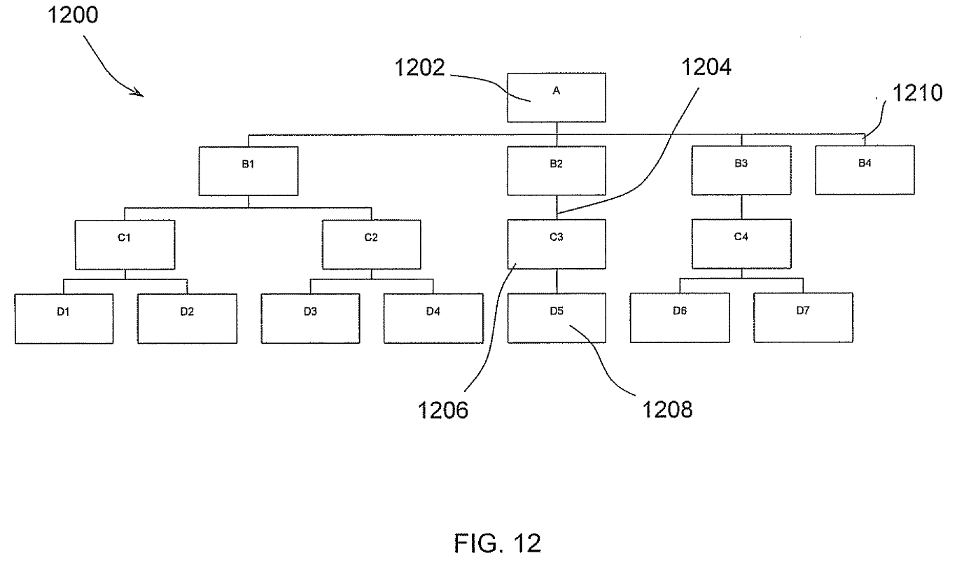

A tree generally has multiple category paths. Multiple paths can be represented as follows, using indented tree notation. For example,
A.B1.C1.D1.
D2.
C2.D3.
D4.
B2.C3.D5.
B3.C4.D6.
D7.
B4.
   is a shorthand representation of the tree 1200 shown in FIG. 12. Here, category “A” is a root 1202. The chain, “A.B2.C3.D5.”, is a category path 1204. Category “C3” is an internal node 1206 and category “D5” is a terminating node, or leaf 1208. There is no constraints on the number of children a node may have. This example shows a number of non-leaf nodes with one, two, or three children. Nor is there any restriction that a tree must have the same depth throughout. In the example, “A.B4.” 1210 is a two-node path to a leaf, whereas all other paths in the tree, such as “A.B1.C1.D1.”, have a total of four nodes. Further, there is also no restriction that all nodes must be different. It may be possible that D1 and D2 are the same category even though they are in different paths.

It will be appreciated that although a tree-like structure 1200 conveniently provides a structure, i.e., relationships to link all categories together, the categories can be organized in any suitable manner, and do not have to be fit into a rigid tree-like structure. For example, instead of a strictly hierarchical structure, it is possible for some nodes below the root node to have “lateral” connections, or for a node to have links to several nodes, instead of only one, at levels above. It may also be possible to have several “root” nodes, instead of only one root node. In particular, it is possible that all categories are treated as “root” nodes, in which case there exists no hieratical structure at all. Further, whether a tree, directed graph, directed acyclic graph, or other structure, a categorization system may also include algorithmic components that take into account user context, time of day, or any other environmental factor or input.

Ideally, users of all systems all agree to a single universal categorization model. This may be not practical, not convenient, or not agreeable to all users. More likely, categorization models of different users may share a common portion. This common portion therefore may be regarded as a system portion or system model, or simply SM. Aside from the system portion, each user may have its private portion, or private model, (or PRM), that varies from user to user. Conveniently, the system portion is managed by a system administrator and individual users manage their own private portions. Each user's categorization model, or individual model (IM), is then the unification of the user's private portion and the system managed system portion. Notationally (but not restricted to the mathematical concept of “union”), IM=PRM ∪ SM. Preferably, the system portion and the private portion are disjoint, i.e., do not overlap. A user then generally needs to manage only the private portion. This can also be generalized to the sharing of categorization models of different systems. For example, users of several systems may participate in a sharing arrangement so that they will share the use of categorization models of the participating systems. System portions managed by the participating systems can be unified to provide a more comprehensive shared portion. The more comprehensive shared portion is then provided to any user of the participating system for unification with the user's private portion.

For example, users within an organization, such as a company or a division of a company, or users served by the same internet service provider (“ISP”), may share a system portion of categorization structure. While such users may each have their own individual views of categorization, such as how information can be or should be categorized, or how the categories should relate to each other, their individual views tend to have certain commonalities. For example, members of the same company may share the categorization of company related information. Or, users served by the same ISP may be residents of the same region and share the way how information related to local community is categorized.

Different organizations or ISPs may cooperate and let users of each other's system use their own system portions of categories. The shared portion of categories for any user of these participating systems will then be the union of all system portions managed by each of the participating systems. Additionally, a “universal” categorization structure or model (or “UM”) can be provided so that any system may use it. Such a “universal” categorization model tends to capture categorization of information of a more general nature. A user's categorization model will then be a union of the universal model, the system portion (which can also be a union of shared portions of participating systems) and the user's own private portion, or notationally, IM=PRM ∪ SM ∪ UM.

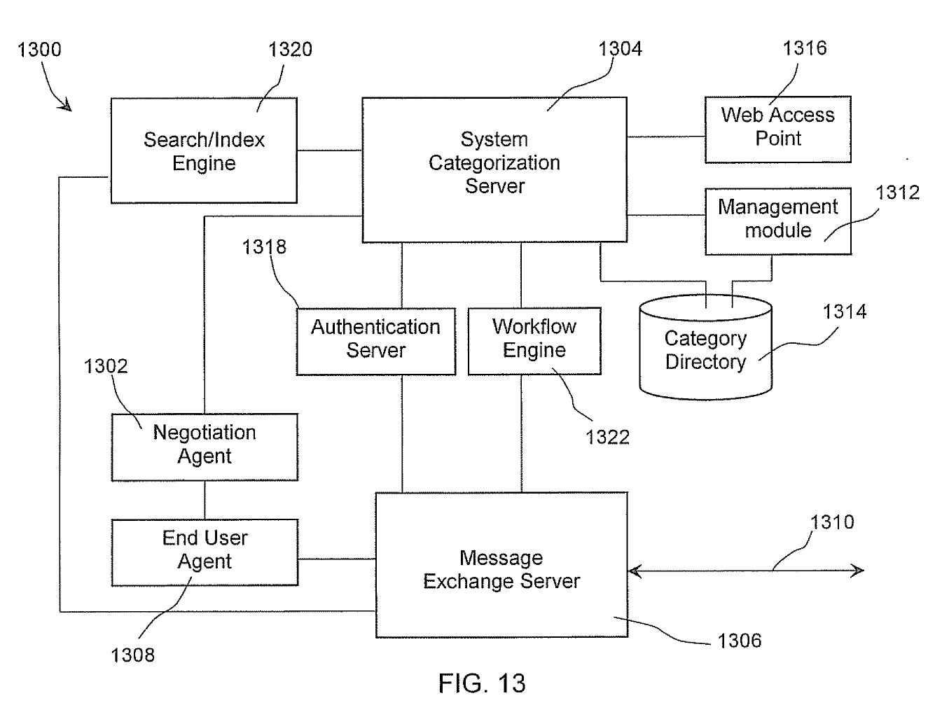

Referring to FIG. 13, there is shown a system 1300 for categorizing and exchanging messages. One example may be an e-mail system with the additional functionality of enabling a user to tag or associate a message with a category, i.e., to categorize a message. Another example may be a voice messaging system that allows a user to tag a message. The system includes at least an end user agent 1302 for a user to send and receive messages. In general, the system 1300 has a number of user agents 1302 for users to send and receive messages. The system 1300 also includes at least a categorization and negotiation agent 1304 for categorizing messages. The categorization and negotiation agent typically can display categories associated with received and categorized messages, and negotiate with a sender's categorization and negotiation agent 1304 to identify a category for an incoming message. The categorization and negotiation agent 1304 is connected to, or can be connected to when necessary, a user agent 1302 for user to access categorization and negotiation agent 1304. The categorization and negotiation agent 1304 is also connected to, or can be connected to when necessary, a system categorization server 1306, which provides access to representations of categorization, such as lists of categories. The system 1300 can also include or be interfaced with a workflow engine 1308. A workflow is defined by a process or processes which comprise a number of related steps or stages. Each step or stage requires specific inputs, or information, from previous step or steps as well as inputs from the current step. The execution of the next step or steps may be routed to different system or systems, or persons, depending on the cumulative information gathered up to the current step. Thus, information concerning steps or stages relating to a process may be provided to categorization and negotiation agent 1304 for categorizing messages or information and for automatically routing the messages or categorized information where a workflow is defined. The system also has a message exchange server 1310, connected to end user agents 1302 of the system whenever needed, for sending or receiving messages over a network link 1312.

The system categorization server 1306 provides management of representations of categorization or categories themselves. A management module 1314 may be provided for this function. Often, an administrator of the categorization system is charged with the responsibility of managing the system portion of representations while individual users are responsible for managing the private portions. Managing representations generally entails managing the categories belonging to the representations. Common management tasks include retrieving, adding, deleting, naming (or renaming) categories. Management tasks may also include establishing certain relationships such as imposing a tree structure to link the categories together. Where such a structure is provided, managing categories also includes changing how a category relates to other categories or moving a category to another node. Further, where privacy or security attributes are provided, management tasks also include managing these privacy or security attributes of shared categories. These tasks may include, for example, determining which senders or receivers, or their respective agents, may access these categories.

As noted, a user's categorization structure can be divided into a system portion and a private portion. The system categorization server 1306 or the management module 1314 can provide an interface for accessing individual users' own private portions of categories, allowing a user to retrieve, add, delete, modify or rename, among others, any of the private categories. Moving a category between system and private portions or to accept or reject requests from a user to move a category into or out of the system portion may also be performed by the system categorization server 1306, or its management module 1314.

Preferably, the system categorization server 1306 has a system category directory 1316 for storing and retrieving data that represent categorization models. The system category directory 1316 may be a software component or service provided by the system 1300. The data stored may relate to the system portion of the categorization model. Typically, data related to the system portion is stored and managed by the system category directory 1316. The system categorization server 1306 provides an interface for system administrators to access the system category directory 1316. The system category directory 1316 can also have a copy of the private categories of each of the users. The system category directory 1316 may also provide support to managing all users' private categories as well.

In one implementation, the system category directory 1316 is responsible for storing categories and providing the categories to the system categorization server upon request. The system categorization server 1306 acts as a gateway or interface between the stored categories and a categorization and negotiation agent 1304.

Categories can be stored in a data structure. The data structure for storing categories can be any suitable structure, such as an extension of the Resource Description Framework (RDF). Such a structure may accommodate extra information such as attributes assigned to a category. Attributes may be used for describing characteristics such as privacy, mappings to the categories of other users, history of category name/path changes, etc.

For improved security, the system categorization server 1306 authenticates a sender and verifies the sender's authorization level prior to exposing the recipient's categories to him. Users not belonging to the same system generally need to be authenticated first. Prior initial registration of such an external user is generally required The system categorization server 1306 may provide web access or other suitable access point for an external user to connect to the system categorization server 1306. For example, web access point 1318 may be used for providing such access, as described earlier. Alternatively, users or system administrator may also accept request of an external user and register the external user. Internal users of the system generally do not need to register, as their identities are already known to the system. Users of a partner system generally also have no need to register first, as administrators of such systems may have already supplied any necessary authentication data or may have configured the partner system to provide the required authentication service. User identity can be managed via the existing authentication directory.

Authorization levels, or permissions, can be determined by a user's group membership. For example, public categories are generally shown to everyone; enterprise-only categories are shown only to members of the same enterprise, or to members of authorized partner enterprises. Private categories are not shown to anyone else, except where exposure to a specific sender is authorized by the recipient. A user can specify, through category attributes or any other suitable designations, that a private category can be exposed to a group of users, such as users of the same system or users from other partner systems. Permissions can be further fine-tuned by setting, for example, values of privacy attributes in individual categories and for individual users. As will be appreciated, permissions may be defined in many different ways based on needs or desirability and the examples provided above are for illustration purposes only.

Preferably, an authentication server 1320 is provided for providing authentication and authorization services. Prior to allowing a user to view or update categories of the system or of a user of the system, the system categorization server 1306 requests the authentication server 1320 to authenticate the user first, and once authenticated, examines the user's authorization level to determine whether the user has the permission to view or update the requested categories. The authentication server 1320 generally stores or has access to required authentication information, such as account name, login ID, password or a user's name. The authentication information may also include group membership or other similar information for determining permissions. The authentication server 1320 is shown connected to the system categorization server 1306 and the message exchange server 1310. This allows the system categorization server 1306 to authenticate a user and subsequently, based on permissions granted to the user, selectively expose the part of categories that the user is authorized to see or modify. The authentication server 1320 may also provide services to message exchange server 1310, for example, for determining whether a user is known to the system when there is an incoming message for the user.

As in an e-mail system without support for categorization, the message exchange server 1310, such as an e-mail server or gateway, connects various user agents 1302 together so that they can send and receive messages for users. The message exchange server 1310, may also be connected over a network to other servers or gateways of other e-mail systems for facilitating the exchange of messages with users of other systems. Any suitable protocols, such as Simple Mail Transfer Protocol (“SMTP”) or Session Initiation Protocol (“SIP”), may be used for exchange of messages, whether text messages such as e-mail messages or voice messages such as digitized telephone conversations.

A user agent 1302 allows a user to create, send, and receive messages and to review and manage the stored messages. Conveniently, a user interface is provided for a user to interact with the system 1300. For example, together with the underlying hardware device, the user interface provides a means for a user to create an outgoing message, such as composing an e-mail message, creating a voice message, generating a paging message etc. The user interface also enables a user to specify delivering information, such as a recipient's address in a messaging system, a recipient's name or some other suitable identifying means, or to specify other information relating to the message, such as subject of the message or importance designation etc. Similarly, the user agent enables a user to process incoming messages, such as reviewing and responding to an incoming message. Advantageously, the user agent also may provide a user with essential tools for managing incoming messages and copies of outbound messages, such as segregated storage of messages, indexing of messages, or filtering unwanted incoming messages.

Not only messages received or sent by the users can be categorized. Other information asset of an organization, such as marketing plans, product development project documents, project plans, human resource records, can also be categorized. In general, any information, such as session transcript of an instant messenger session, e-mail message text, digital recording of a telephone conversation, or multimedia recording of a slide presentation including audio recording, video clips, graphics, texts etc, may be part of information asset. The system categorization server 1306 may be configured to provide an interface for categorizing information assets other than e-mail or other messages to include any form of information asset.

Categorized messages and organization information assets can be indexed based on their categories. For example, the search engine 1322 shown in FIG. 13 is configured, i.e., has programmed instructions, to index all stored messages based on categories, which facilitates searching by category. The search engine 1322 can be configured to index and search information assets such as documentation created by an organization or data retrieved using ftp, categorized e-mail messages, voice messages, transcripts of instant messaging sessions, etc. or any combination thereof

Aside from category-based indexing and searching, the system also provides category-based information management, such as storing, displaying, filtering or downloading. Messages and information assets can be stored separately based on categories. For example, messages can be filed into different “folders”, or logical views into aggregations of assets, based on categories. For a mobile e-mail message user, the user may also choose to download to the mobile device for storage only messages of certain categories, but not other categories. Messages can also be filtered based on categories. For example, a user may choose to filter out, or delete, certain messages based on the messages' categories. Thus, a user may be relieved the burden of reviewing messages that the user does not wish to receive or has no interest in reviewing. Such category based storage and filtering can be performed at either the user level through user agents or at the system level, by the system categorization server 1306 or the message exchange server 1310, or at both the system and user levels.

The categorization and negotiation agent 1304 provides support for negotiating a category for an outgoing message with its intended recipient. During a categorization and negotiation session, the categorization and negotiation agent 1304 is connected to another user's user agent or categorization and negotiation agent and engages in a dialog, as will be described in great detail below and also shown in FIGS. 2-8 earlier, above. The categorization and negotiation agent 1304 can also selectively connect to a system categorization server and let the system categorization server to negotiate on behalf of the recipient. The categorization and negotiation agent 1304 can also connect to the system category directory 1316, where necessary or desirable, to inquire about another user's representation of categorization or categories. This may be needed, for example, when attempting to categorize an outgoing message with a category not in the listing of the recipient's categories but a mapping to a category of the recipient may be appropriate, as will be described below, and also shown in FIG. 11.

The categorization and negotiation agent 1304 may also provide support for allowing a user to access or manage categorization structure. Conveniently, the categorization and negotiation agent 1304 connects to a user agent 1302 to allow user access; or it can provide its own user interface. A representation of the categorization structure can be displayed, either in its entirety if the categorization structure is sufficiently limited in size and can be reasonably displayed on the underlying display device, or showing a portion thereof if the size of the display device is not adequate for showing the entire structure. As will be understood, if only a portion is shown, navigation tools or other means for selectively displaying part of a categorization structure will be provided so that a user can have access to each and every element of the categorization structure. A user can add, delete, name or rename, or move a category in its private portion or move a category or request its move between private and system portions. Like the system categorization server or its management module, the categorization and negotiation agent 1304 can also provide unification of system and private portions of the user's categorization structure or the unification of the system portion, the private portion and an additional categorization structure provided by a partner system to produce a comprehensive categorization representation.

Conveniently, each time a new category is added, an existing category is renamed, or a category is moved (whether within the system portion or the private portion, or moved between the system and the private portions), the system may automatically re-index the stored messages accordingly. Similarly, if category-based storage is supported, the stored messages may also be reorganized, in accordance with the addition, renaming or movement of categories. Advantageously, the system can track, namely save, history of change of categories. A tracking module may be provided for this purpose. This may be particularly useful when the system has memorized a mapping of users' categories for future use as will be described in great detail below but one of the user's categories has changed.

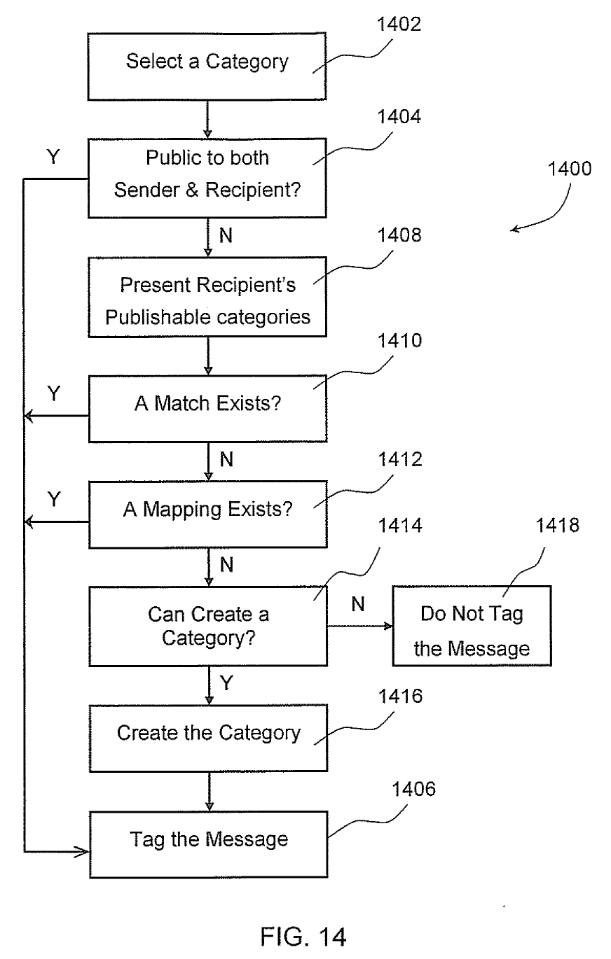

The operation of the system 1300 will now be described with reference to a categorization process illustrated in FIG. 14 shows steps of a process for categorizing an outgoing message when a user prepares a message for sending to a recipient, the user's categorization and negotiation agent initiates a categorization and negotiation session 1400. Preferably, a category to be associated with a message is one that already exists in the recipient's categories and is represented in the sender's categories as well. For example, the category selected can be one that is part of the publicly shared categories of the sender and the recipient. Categories belonging to the shared portion of a system's categories exist in representation of categorization of all users of the system. The sender generally first selects a category that is suitable for the message (step 1402). The system determines if the selected category is shared by the sender and the recipient (step 1404). If one such category already exists, the category is identified and the categorization and negotiation agent 1304 tags the message with the selected category (step 1406). If this is the first time the sender sends a message to the recipient, the sender may also first query whether the receiver's system supports categorization of messages and, if so, requests that the receiver sends a list of all of its categories that the sender is entitled to see, i.e., a list of the sender's publishable categories. The sender may cache the list. This helps reduce future network data transmission and may help speed up the negotiation session 1400.

If the selected category is not one of public categories shared by both the sender and the recipient, the categorization and negotiation agent 1304 presents the recipient's publishable categories to the sender (step 1408). The publishable categories are categories known to a user and exposable to the other party, for example, based on the other party's permission. The categorization and negotiation agent 1304 can display the publishable categories to the sender for selection (see, for example, FIGS. 9-11), or automatically examine the recipient's publishable categories to determine if the category selected by the sender is publishable. Advantageously, prior to presenting the sender with those categories which the sender is entitled to view, the system may filter out irrelevant categories based on an analysis of the proposed message text. In other words, the sender would be presented only with categories that are a likely match, given the text of the entire message. This helps reduce the amount of data that needs to be transmitted.

If the sender selected category matches one of the publishable categories (step 1410), the message is tagged with the matched category (step 1406). Otherwise, the system determines whether there is a mapping from the sender selected category to one of the publishable categories of the recipient (step 1412). The sender can also determine, based on a review of the publishable categories of the recipient, whether the selected category can be mapped to one of the publishable categories.

Mapping generally occurs when there is not an exact match but one of publishable categories can be mapped to the selected category. For example, “A.B.C.D” in the sender's categorization model PRM₀ may actually be represented by “A.B.X” in the recipient's categorization model PRM₁. There is then a mapping:
A.B.C.D→_{α}A.B.X
Where α is a partial mapping—there may be paths in the PRM₀ that are not represented in PRM₁. In practical terms, this means that there may be a mapping from some of sender's categories to some of recipient's categories. The mapping may simply reflect a difference in naming convention, or a difference in how the sender and the recipient classify information. In any event, the sender may decide that “A.B.X” actually corresponds to “A.B.C.D”, is equivalent to “A.B.C.D”, or that the message can be appropriately categorized as “A.B.X”. This establishes a mapping between the sender's “A.B.C.D” and the recipient's “A.B.X”. The sender's category directory service can save this mapping for future use. With mappings recorded, the system can also leverage mappings established by all users to find a mapping from one user's category to another user's category (or categories if multiple paths of mappings exist). For example, when the next time the same sender categorizes a message to the same recipient as “A.B.C.D”, the system can automatically map “A.B.C.D.” to “A.B.X” of the recipient. It will be understood that the mapping A.B.C.D→_{α}A.B.X is bi-directional, i.e. the reverse also exists. When the next time the recipient sends a message to the sender, such as when responding to the sender, the reverse of the mapping can be used, namely “A.B.X” of the recipient will be mapped to “A.B.C.D.” of the recipient.

It will be appreciated that the mappings are not necessarily direct mappings. For example, suppose that user A sends a message to user B, using a mapping from “PRM_{A}.A.B.C.” to “PRM_{B}.X.Y.Z.”, B forwards the message to user C, using the mapping “PRM_{B}.X.Y.Z.” <-> “PRM_{C}.O.P.Q.”. Here, A, B and C are all users of the same system. Subsequently, C responds to B and A—a fairly common scenario. Because the reply is automatically categorized by the system as “PRM_{C}.O.P.Q”, the reply will be received by B categorized as “PRM_{B}.X.Y.Z”. Furthermore, C's local system will leverage the mapping between A and B to ensure that the reply is received by A categorized as “PRM_{A}.A.B.C.”. More generally, a mapping may include a series of intermediate mappings to and from categories of one or more intermediate users. For example, a mapping
X→Y
may consist of a series of intermediate mappings
X→Z₁→Z₂→Z_{3 . . .} →Y
where Z₁, Z₂, Z₃ etc are intermediate mappings. In other words, intermediate mappings may be chained to obtain a final mapping. It is also possible that, where intermediate mappings are included, different series of intermediate mappings may produce the same final mapping X→Y. For example the mapping X→Y may also consist of
X→T₁→T₂→T_{3 . . .} →Y

With all users' categories and mappings of categories stored and managed by the system, e.g., by the system categorization server 1306, or system category directory 1316 when one is provided, the system can use the mapping information to minimize the effort required for a sender to categorize messages for some of the recipients. When one category for one recipient is identified, if mappings from the identified category to other categories of other recipients exist, such information can be used. Where one recipient has several mappings to the identified category, the system may be configured, or be provided with an optimization module, to select an optimized series of intermediate mappings. The optimization may be one that requires the least number of intermediate mappings, or may be one that utilizes one intermediate mapping that is most frequently used. Of course, other rules of optimization can also be devised and used.

It is possible that the sender and the recipient do not both have the same category in their respective representations of categorization, and that the sender selected category cannot be mapped to a publishable category of the recipient. Optionally, the categorization and negotiation agent 1304 allows the sender to create a new category in the recipient's categorization structure. If the sender is allowed to create a category in the recipient's categorization model (step 1414), a new category corresponding to the selected category is then created and added to the recipient's categorization model (step 1416) and the message is so tagged. FIG. 9 provides one such simple example. In the rare event that the categorization and negotiation agent 1304 cannot find a match, cannot find a mapping, and cannot create a category, the message will not be categorized (step 1418) and will be sent to the recipient without a category associated therewith. Alternatively, the system can always provide a default category, such as “general” to avoid this from happening.

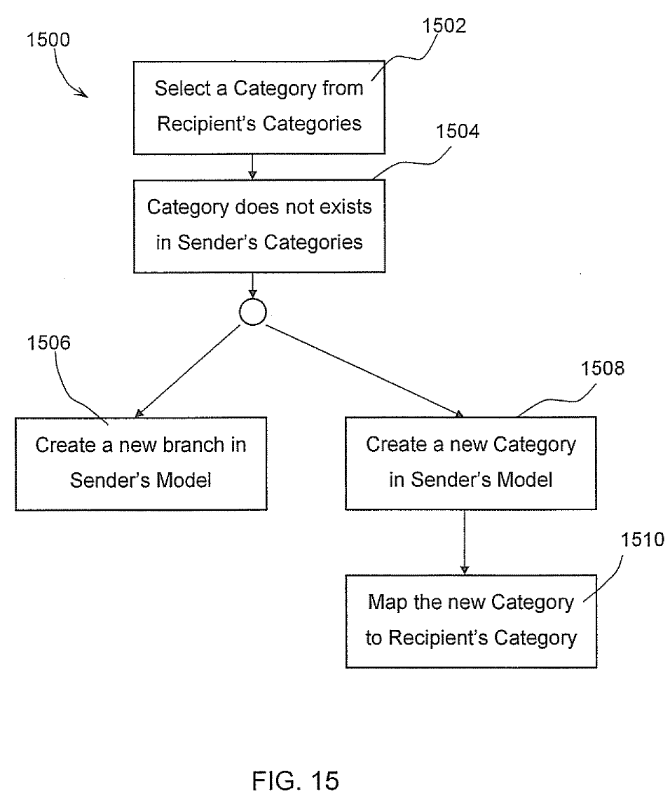

As will be appreciated, the process described above can be varied, as long as both the sender and the recipient can agree on an appropriate category for the message. For example, when a suitable category is not shared by both the sender and the recipient, the sender may also select a category from the recipient's publishable categories (step 1502) instead of from its own categories. In other words, the sender categorizes the message using one of the recipient's categories that does not exist in the sender's own categorization model as yet (step 1504). Thus, the message is categorized accordingly from the recipient's perspective. From the sender's perspective, the message has yet to be categorized in a way that will be recognizable in his own context. At this point, the sender has at least two options, as illustrated in FIG. 15. The sender can “adopt” the category or create his own category. To “adopt” the category, the sender creates a corresponding branch in the sender's PRM (step 1506). For example, if the recipient's category selected is “Personal.A.B.C.”, the sender will create a new category “C” in a new category path “Personal.A.B.C.”. Alternatively, instead of adopting, the sender can create a new category (step 1508) and map it to the recipient's category (step 1510). For example, the sender can create a new category “Y” in its own category path, say “Personal.X.Y.” and then record a mapping between the sender's “Personal.X.Y.” and the recipient's “Personal.A.B.C.” Such a mapping is also recorded by the recipient's system. In the future, if the recipient uses “Personal.A.B.C.” in a message sent to the sender, the message can be categorized as “Personal.X.Y.” for the sender.

The process described in reference to FIG. 14 of FIG. 15 can be further varied for sending messages to multiple recipients. The same steps can be followed by the categorization and negotiation agent 1304 to negotiate with each one of the recipients to arrive at an acceptable category. When there are a large number of recipients, for example when sending a message to all team members of a company-wide project, this can be a tedious process. However, the system can ease the burden on the sender, where possible, by leveraging any existing mappings between the categorization models PRMs of the recipients, as already described.

When prompting for categories, for example, through a user interface shown in FIG. 9, the categorization and negotiation agent 1304 will first request categorization using the PRM of a recipient Rᵢ that has the highest number of mappings to the other recipients. When sender selects a category for Rᵢ, the categorization and negotiation agent 1304 checks if that category is mapped between Rᵢ and any of the other recipients. The categorization and negotiation agent 1304 can perform this check itself, or more preferably, send the request to the system categorization server 1306, which will in turn perform the check. For those recipients for whom there is a mapping, the categorization and negotiation agent 1304 or system categorization server 1306 will apply the mapping, and the sender will no longer be prompted to select a category for those recipients.

Furthermore, if the sender selects categories PRMᵢ.A.B.C. for recipient Rᵢ and PRMⱼ.X.Y.Z. for recipient Rⱼ, the system, which may delegate the task to the categorization server 1306, will create a mapping between those two categories, and preserve this mapping in the local stores for Rᵢ and Rⱼ. This is in addition to whatever mapping already selected between one of the sender's own categories and the categories from recipients Rᵢ and Rⱼ. All of the mappings will be preserved for future use. Preferably, this mapping will be persistent, i.e. preserved in each user's local PRMs. The mapping may be preserved only for a limited period of time so as to optimize the tradeoff between knowing this mapping, which is useful for future exchanges, and the storage overhead. The preservation period may be specified by each user, or determined by the system.

As described earlier, categorization is not limited to messages, but may be extended to information assets. Information assets created or developed during the course of a corporate process can be conveniently tracked through a categorization process, as described below. Information such as the specifics to which the corporate process is being applied, the steps being completed, and other similar information can all be properly categorized and tracked. This leverages the potential for a particular asset (an e-mail message can be one such asset) to be tagged with multiple, non-exclusive categories, each of which has value assigned.

For example, a “Credit Check” process might have a number of steps, such as collecting information from a prospect, running the information by one or more agencies, evaluating the information and making a recommendation, and finally making a decision. The submodel to represent this might look like this:
SM_{Enterprise}.Processes.Process{Value=CreditCheck}
   .Prospect{Value=“Acme, Inc.”}
   .Step{Value=“ReviewApplication”}
   .Deal{Value=Quote 001234}
   .SalesRep{Value=Rick Garcia}
   .SalesOpsContact{Value=Cindy Lee}

Information related to the “Credit Check” process can be appropriately categorized based on this sub-model. For example, all information collected or received at or for the step of Application Review can be categorized with the category SM_{Enterprise}.Process.Step{Value=“ReviewApplication”}. Information can also be categorized based on, for example, Deal, SalesRep etc. Information assets so categorized can be easily searched. Examples of searches can include:
Search for all assets related to the “Credit Check” process, where Cindy Lee was the Sales Operations contact.
Search for all assets related to the “Credit Check” process for customer Acme, Inc.
Search for all assets related to the final step of a “Credit Check”—this could be farther refined to sort into approved and denied applications.
Search for all Leave of Absence requests rejected by John Doe
Search for all messages related to defect 1234.

At the last step, the information asset is tagged and similar notation could be used in a search query. Such a search query may be expressed in terms of categories in this sub-model. Search queries formed from categories can be entered by a user, or created programmatically using a special-purpose search engine, or any other suitable method. Information assets retrieved using these search queries will then be relevant to the particular sub-model and the categories defined therefore.

The system also provides similar means for an administrator of the system category directory to define concepts, such as templates for new processes—the various categories or attributes that may be associated with each process, and for some of them, the attribute value ranges. The types of queries required with regard to a process will dictate the template to be created by the system administrator for tagging assets relevant to that process.

When the system includes the workflow engine 1308 that maintains awareness of process states, the system can provide an even more dynamic process view. A message, such as an e-mail message or a voice message, may be tagged, or categorized, based on how the message relates to the steps of a process or processes. A user no longer needs to “remember” the state the process is in, or what the next step is, for categorization purposes—all that information can be maintained by the workflow engine, and offered up for selection of categorization options, or entered automatically by the system or by the workflow engine. Information assets delivered by, or created independent of, messages can also be categorized with the help of the workflow engine 1308.

For example, a sender might specify a required deadline for the recipient to take the next step in the workflow. Knowing the state the process is in and the next steps, the system can take the requested action and put a task to complete the next step on the recipient's “to do” list with the requested deadline. This allows a workflow engine to use category information for routing and state processing purposes. Thus, information delivered together with the request can be categorized appropriately as belonging to the next step. Rather than having to read the message and deciding the next step, the recipient will automatically have a “new” task entry entered into his calendar. A query for newly scheduled activities (all of them, or perhaps only those associated with a particular process or workflow) will then display the proper context and content to the receiver. All information captured and categorized as belonging to the next step can also be indexed and searched and then provided to the receiver upon commencing the next step, or the task. This tends to be more efficient than reading, parsing and planning action on the basis of an e-mail message that reads, for example, “About securing approval for that hiring requisition [. . . ] and you need to get this to your supervisor by next Friday, or sooner if possible . . . ”. Instead, the message is tagged as belonging to a “security approval” step in hiring process and a task associated with the step is automatically created.

As another example, the system allows context-sensitive IM (instant messaging) session initiation. For example, if a first user is reading an e-mail message and as a result decides to initiate an IM session with a second user, the session will be categorized, by default, in the same manner as the e-mail message. The second user will see the IM request with those categories, and can use that information to decide whether to join the session. By the same token, the IM session, once completed, will be saved under the same categories associated with the e-mail message that promoted the initiation of the IM session. This helps keep all information assets properly categorized and stored, which facilitates category based indexing and searching and eventual easy retrieval of information.

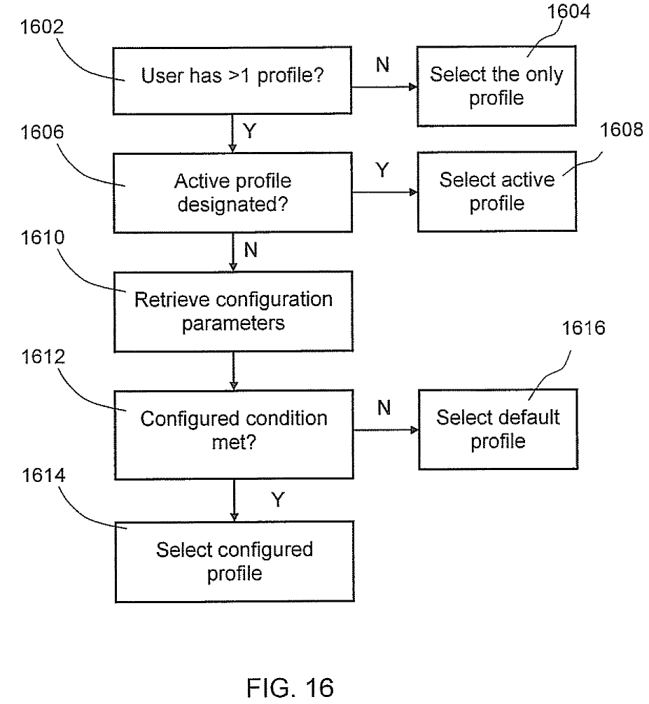

In a further variation, some users may have several different representations of categorization, or “profiles”. For example, a user may categorize information associated with work in one way and categorize other information based on a different classification scheme. The user may then create or use a “work profile” for categorizing work related information and create or use another profile, for example a “home profile”, for categorizing information not strictly related to work. A user may designate one of the two profiles (or more profiles, if more have been established) as an active profile, so that during a negotiation session, the active profile, and none of the other profiles, will be used. As described before, a user's presence information can also be used for selecting a profile and a representation of categories for a negotiation session. The system may help automating the process in designating an active profile. FIG. 16 illustrates one such example.

Referring to FIG. 16, before or at the beginning of a negotiation session, such as the one negotiated in FIG. 14, the system queries whether a user, in this case, receiver, has more than one profile (step 1602). The only profile will be selected and designated as an active profile if the user does not have more than one profile (step 1604). If the user has more than one profile, the system next queries whether the user has already selected one of them as an active profile (step 1606). If so, the user selected profile will be designated as the active profile. If no profile has been selected by the user, configuration parameters are retrieved (step 1608). A user may configure the system, through a set of personalized configuration parameters, to automatically select a profile when at least certain configuration conditions are met (step 1612), or to select a default profile if none of the configuration conditions is met (step 1614). For example, the system may query whether a user is connected to the system through a workstation located in the office. If so, the “work profile” may be selected accordingly. A user may also connect to the system remotely and configure the system to select the “home profile” accordingly when this is detected. A user may also have several different computation environments, each corresponding to a different engineering project. Each engineering project may have a corresponding project profile, in which case, the system can be configured to automatically designate the corresponding project profile as the active profile based on the user's computation environment. Of course, other configuration parameters may also be used for the system to automatically switching between profiles.

Numerous examples have been provided to illustrate the categorization process and the management of representations of categorization, with references to systems that include categorization server and those that do not. It will be appreciated that providing a categorization server is only for convenience, and many features of the present invention can be realized without a categorization server. For example, in a peer-to-peer configuration, membership of users in such an individually managed configuration is generally assigned by each user. Each user may accept requests from other users to “register” and assign an appropriate membership to these other users. As a more concrete example, a user may assign all family members and relatives to a first group and all colleagues to a second group. Members of the first group and second group may share a common portion of categories, now agreed to by all members of the groups. Individual members may all have their own private categories, selectively exposable to members of the first group only, members of the second group only, or only a few other users, not decided by group membership. Each user may also retain copies of and manage mappings of categories from the user's categories to the other users' categories. This functionality may be provided by a modified version of the categorization and negotiation agent 1304. The modified agent may act like the categorization server described earlier. That is, the modified agent records mappings used during any negotiation and categorization session, identifies indirect mappings that may involve intermediate users, finds the optimized indirect mappings, etc. As now each user stores only mappings known to the user, the user may not know all mappings between other users. The modified agent can query agents of other users for these other mappings in order to identify all available indirect mappings, or all indirect mappings involving a pre-selected number of intermediate users.

Similarly, when a sender updates its representation of categorization during a negotiation and categorization session, for example, by creating a new category or creating a new mapping, such change may be “propagated” to other users. The propagation may be simply a notification of the change, so the other users will have the information when next time communicating with the sender as well as the recipient(s) involved. The propagation may also be sending a copy of modified representation to other users for other users to update their own representation accordingly. This will also allow each user as well as all other users communicating therewith to update their representations of categorization over time, i.e., to evolve their categorization models.

In one implementation, the modified agent incorporates all functionality of the categorization server, including its management module, the system category directory and the authentication server, and can thus act entirely independently in a peer-to-peer configuration without any support from a system categorization server, system category directory etc.

Various embodiments of the invention have now been described in detail. Those skilled in the art will appreciate that numerous modifications, adaptations and variations may be made to the embodiments without departing from the scope of the invention. Since changes in or additions to the above-described best mode may be made without departing from the nature or scope of the invention, the invention is not to be limited to those details provided for illustration but only by the appended claims.

What is claimed is:

1. A system for categorization of messages communicated by users of a message exchange system, the message exchange system including at least one user agent, the categorization system comprising:
a categorization server for supplying representations of categorization of information,
one or more categorization and negotiation agents for categorizing the messages, said one or more categorization and negotiation agents each having a communication interface for connecting to one of another categorization and negotiation agent, the categorization server, or the at least one user client,
wherein a categorized message is associated with a category belonging to the representations of categorization.

2. The system of claim 1, wherein the representations of categorization share a common portion and the categorization server has a management module for unifying the common portion with a part of one of the representations of categorization to form a copy of the one representation.

3. The system of claim 2, wherein the management module is configured for receiving a second representation of categorization and for unifying the second representation, the common portion, and the part of the one of the representations to form a unified representation of categorization.

4. The system of claim 2, wherein the management module is configured for modifying the representations of categorization.

5. The system of claim 4, wherein the modification of a representation includes modifying a category belonging to the representation, deleting a category from the representation, and adding a category to the representation.

6. The system of claim 1, wherein the system has at least two of the representations as being associated with a user and designates one of the at least two representations as active upon a pre-determined criteria being met.

7. The system of claim 1, wherein the categorization server is configured to authenticate a user for selectively supplying the representations of categorization to the user based on permissions assigned to the user.

8. The system of claim 7, wherein the representations of categorization include privacy attributes and the permissions are based on the privacy attributes.

9. The system of claim 7, wherein the permissions are based on group membership of the user within the system.

10. The system of claim 1, wherein the categorization server farther comprises a category directory service module for providing the representations of categorization to the users.

11. The system of claim 10, wherein the categorization server further comprises a tracking module for retaining a history of changes of the representations of categorization and providing the history to the category directory service module.

12. The system of claim 11, wherein the tracking module is configured to record mappings between categories of the users of the system and to provide the mappings to the category directory service module.

13. The system of claim 12, wherein the mappings include intermediate mappings from and to categories of one or more intermediate users.

14. The system of claim 13, wherein the tracking module further includes an optimization module for selecting an optimized mapping including the intermediate mappings.

15. The system of claim 14, wherein the optimization module selects the optimized mapping based on number of the intermediate mappings included therein.

16. The system of claim 14, wherein the optimization module selects the optimized mapping based on frequency of the intermediate mappings used.

17. The system of claim 1, wherein the messages include any one of e-mail messages, digitized audio messages, digitized video messages, digitized graphics, electronic text messages, and any combination thereof.

18. The system of claim 1, further comprising a storage unit, said storage unit having segregated areas for storing in each of the segregated areas messages that are associated with a common category.

19. The system of claim 1, further comprising a storage unit and an indexing module for indexing the stored messages based on categories associated therewith.

20. The system of claim 1, further comprising a storage unit and a searching module for searching the stored messages based on categories associated therewith.

21. The system of any one of claims 19 and 20, wherein the stored messages include messages received by and sent from the users.

22. A message exchange system, the system comprising:
one or more user agents for users to exchange and manage messages;
one or more categorization and negotiation agents for categorizing the messages, each one of the one or more categorization and negotiation agents being connected to one of the one or more user agents, and
a categorization server for supplying representations of categories to the one or more categorization and negotiation agents, said each one categorization and negotiation agent being operable to communicate with at least of one of said categorization server and another categorization and negotiation agent;
wherein a categorized message is associated with a category belonging to the representations of categories.

23. The system of claim 22, farther comprising a category directory for storing and administering the representations of categories.

24. The system of claim 23, wherein the representations of categories include a common portion shared by the users of the system, the common portion being managed by the category directory.

25. The system of claim 24, wherein the category directory provides an interface for connecting to said one or more categorization and negotiation agents for a user to manage a private portion of the at least one of the representations of categories, a union of the private portion and the common portion forming a copy of the at least one of the representations.

26. The system of claim 25, wherein the category directory is operable to combine a second system portion supplied by a second categorization server, the common portion and the private portion to form a combined representation of categories.

27. The system of claim 22, further comprising a storage unit for storing received messages and copies of sent messages.

28. The system of claim 27, further comprising an indexing subsystem for indexing the stored messages according to categories associated therewith.

29. The system of claim 28, wherein the indexing subsystem farther indexes the stored messages based on weighting parameters.

30. The system of claim 27, further comprising a search subsystem for searching the stored messages according to categories associated therewith.

31. The system of claim 22, further comprising a workflow engine for managing a schedule of workflows, wherein the workflow engine adds a task to the schedule upon receiving a categorized message associated with a category that has a state attribute with a non-empty value.

32. In a system for exchanging messages among users of the system, the system including a message exchange server, a categorization server for supplying a listing of categories, and a user agent connected to the message exchange server, the user agent comprising:
a user interface for the user to send and receive messages;
a categorization and negotiation subsystem connected to the user interface, said categorization and negotiation subsystem being selectively connectable to the categorization server and being configured to communicate with another user agent to negotiate a category for a message, the negotiated category being based on the listing of categories.

33. The user agent of claim 32, further comprising a storage unit for storing received messages and copies of sent messages.

34. The user agent of claim 33, further comprising an indexing unit for indexing the stored messages according to categories associated therewith.

35. The system of claim 34, wherein the indexing unit further indexes the stored messages based on weighting parameters.

36. The user agent of claim 33, further comprising a searching unit for searching the stored messages according to categories associated therewith.

37. The user agent of claim 32, wherein the categorization and negotiation subsystem is further selectively connectable to a second categorization server for obtaining a copy of the listing of categories.

38. The user agent of claim 37, wherein the categorization and negotiation subsystem combines the listing of categories and a second listing of categories supplied by the second categorization server to produce a combined listing of categories.

39. The user agent of claim 37, wherein the second categorization server includes at least one system categorization agent for negotiating the category on behalf of the user agent and the user agent is adapted to receive the category from the at least one system categorization agent for categorizing the message.

40. A method of categorizing information, the method comprising the steps of:
providing an initial representation of categorization of information, said representation including a plurality of categories, said initial representation being provided in a session of receiving the information from a sender;
negotiating with the sender to make a modification to said initial representation during said session for categorizing said received information;
associating a category with the received information, said category being negotiated based on the modified representation; and
providing said modified representation in subsequent sessions of receiving further information.

41. The method of claim 40, wherein the modification includes a mapping between a first category in the plurality of categories and a second category included in the sender's representation of categorization.

42. The method of claim 41, further comprising the step of:
querying a categorization server to obtain a second mapping between said second category and a third category in an intermediate user's representation of categorization and a third mapping between said first category and said third category, and
forming said mapping from said second mapping and said third mapping by chaining said second and third mappings.

43. The method of claim 40, wherein the modification includes at least one of adding a first new category to the plurality of categories, adding a second new category to the sender's representation of categorization, and mapping one of said first new category and said second new category to the category.

44. A method of transmitting messages in a message exchange system, the message exchange system including a user agent of a sender for transmitting a message to a receiver, and a categorization server for supplying a listing of categories, the method comprising the steps of:
obtaining the listing of categories from the categorization server;
negotiating a category with the receiver, said category being selected based on the listing of categories;
associating the message with the category; and
sending the message associated with the category to the receiver.

45. The method of claim 44, further comprising the step of, prior to obtaining the listing, querying the receiver whether the receiver supports categorization of received messages.

46. The method of claim 44 wherein the listing of categories includes a system portion shared by users of the message exchange system and a private portion, and the step of obtaining the listing of categories includes:
obtaining the system portion and the private portion; and
combining the system portion and the private portion to produce the listing of categories.

47. The method of claim 46 wherein the step of negotiating the category includes at least one of selecting the category from the system portion, selecting the category from the private portion, and establishing a mapping between the category and a second category selected from the private portion.

48. The method of claim 44, further comprising the steps of:
authenticating the sender,
determining a permission level of the sender, and
publishing a restricted listing of categories based on the permission level,
wherein the step of obtaining the listing of categories includes obtaining the restricted listing of categories and the step of negotiating includes one of selecting the category from the restricted listing and establishing a mapping between the category and a second category selected from the restricted listing.

49. A computer readable medium containing computer program instructions for classifying messages sent over a communications network in a message exchange system, the message exchange system including a sender agent for sending a message, a receiver agent for receiving the message and a categorization server, said computer readable medium containing instructions for:
obtaining the listing of categories from the categorization server;
negotiating a category to be associated with the message, said category being negotiated between the sender agent and one of the receiver agent and the categorization server based on the listing of categories;
associating the message with the category; and
sending the message associated with the category to the receiver.

50. The computer readable medium of claim 49, wherein the listing of categories includes a system portion shared by users of the message exchange system and a private portion, and instructions for obtaining the listing of categories include:
obtaining the system portion and the private portion; and
combining the system portion and the private portion to produce the listing of categories,
wherein the instructions for negotiating the category include one of selecting the category from the system portion, selecting the category from the private portion, and mapping the category to a second category selected from one of the system portion and the private portion.

51. The computer readable medium of claim 50, said computer readable medium containing further instructions for recording the mapping and providing the recorded mapping to users upon request.

52. The computer readable medium of claim 49, said computer readable medium containing further instructions for:
authenticating the sender,
determining a permission level of the sender, and
requesting the categorization server to publish a restricted listing of categories based on the permission level,
wherein the instructions for obtaining the listing of categories includes obtaining the restricted listing of categories and the instructions for negotiating the category include one of selecting the category from the restricted listing and establishing a mapping between the category and a second category selected from the restricted listing.

53. The computer readable medium of claim 49, said computer readable medium containing further instructions for:
storing at least one of received and sent messages associated with the category,
providing one of indexing and searching of said stored message according to a categorization of said stored message.

54. The computer readable medium of claim 49, said computer readable medium containing further instructions for modifying said listings of categories during negotiation of the category.

55. The computer readable medium of claim 54, wherein the modification includes at least one of adding a first category to the listing of categories and modifying a second category of the listing of categories.

56. The computer readable medium of claim 55, said computer readable medium containing further instructions for retaining a history of the modification and providing the history to users upon request.
